(19) United States
(12) Patent Application Publication
(10) Pub. No.: US 2009/0143706 A1
(43) Pub. Date: Jun. 4, 2009

(54) NECK BELT APPARATUS

(76) Inventor: Eliseo Acosta, Chicago, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/948,511

(22) Filed: Nov. 30, 2007

(51) Int. Cl. A61H 1/00

(52) U.S. Cl. 601/46

(57) ABSTRACT

A neck belt apparatus is disclosed. The neck belt apparatus includes a band which is placed around the neck of a user. Optionally, an adjustable fastener enables fitting to a variety of neck sizes. The band includes a heating element to provide heat to the neck of a user to enable weight loss in the neck or lower chin of the user. Optionally, a plurality of vibrating devices are provided and arranged to provide vibration to the neck. This can potentially enhance weight loss or provide comfort. Padding is included for comfort. The apparatus enables a user to address a need for weight loss in the neck area. Alternatively, the apparatus can provide pain relief. Switches can be provided to adjust settings for both vibrating devices and heating element. The apparatus is ideally alternatively powered via a power cord or a rechargeable battery.

### BACKGROUND OF THE INVENTION

1. Field of the Invention

The present invention relates to weight loss devices, and more specifically to a device for reducing unwanted neck fat.

2. Description of the Related Art

Weight loss is a common objective of a large percentage of the population. Many methods for weight loss have been provided. For example, various diets, exercise programs, and exercise equipment exist.

While various manners in which weight loss can be effective for general weight loss, there are sometimes specific areas of the body where targeted weight loss efforts may be needed. For example, when an individual has lost weight, the individual may have residual fat in the front of the neck or lower chin area.

Presently, there is a lack of sufficient manners in which to address targeted weight loss in the neck and lower chin region. Conventional devices fail to address the needs of those attempting to lose unwanted weight in these regions.

### SUMMARY

In view of the deficiencies described above, it is an object of the present invention to provide a neck belt apparatus for weight loss or comfort.

It is a further object of the present invention to provide a neck belt apparatus to fit a variety of neck sizes.

In view of these objects and others, the present invention is a neck belt apparatus. The neck belt apparatus of the present invention is designed to fit around the neck of a user. The apparatus assists the user in losing weight in the neck area. Alternatively, it may assist in relieving pain in the neck area.

The neck belt apparatus includes an outer surface. The outer surface is preferably moisture resistant so as not to absorb a substantial amount of perspiration from a user. Furthermore, by not being too porous, the outer surface being placed against the neck may increase heat and perspiration about the neck area of the user.

Inside the neck belt apparatus is disposed a heating element. The heating element is arranged to apply heat to the neck of the user. In this manner, further perspiration may be induced by the apparatus.

Optionally, also inside the neck belt are disposed a plurality of vibrating devices. These devices are arranged to provide vibration to the neck of the user. The vibrating provides movement, works the tissue, may increase perspiration, etc. This may merely provide comfort, however, in doing so, weight loss in the neck area may be enhanced. Furthermore, pain relief may be accomplished via a massaging effect.

The band size is ideally adjustable to fit a variety of neck sizes. Furthermore, padding is disposed between the electronic devices and the outer surface for comfort. Such padding may be made of any suitable material, including but not limited to a sponge material or other padding material. Ideally, such padding material is heat resistant.

The optional vibrating devices of the apparatus will require a power source. The source of power may be a power cord adapted to receive power from an AC outlet or electrical power source. A DC converter may be employed between the power source and the vibrating devices. Alternatively, a rechargeable battery may be used to power the device. This would enable the neck belt apparatus to be used in such a way that the user may be mobile, or need not be located in close proximity to an external power source.

The heating element of the apparatus is ideally powered via the same power source as that which provides power to the vibrating devices, if present. The combination of vibration and heat, when both are provided by the neck belt apparatus, focuses motion, heat, vibration, perspiration, and massage in the neck area of the user. Thus, this may enable a user to reduce unwanted fat tissue in the neck region. In addition, discomfort, pains, and aches in the neck region of the user can be reduced by the unique combination of features of the apparatus.

In additional, the heating element and optional vibrating devices can be positioned to contact not merely the neck of the user, but the under portion of the chin and upper neck of the user in order to direct the weight loss and comfort features to those portions of the user's body.

The neck belt apparatus of the present invention can be used during travel, while on the go, while seated, or while lying down. A user may even utilize the neck belt apparatus of the present invention while exercising in another manner.

In various embodiments, the outer surface is not removable from the apparatus. However, in certain optional embodiments, portions of the neck belt apparatus may be removed, such as the outer surface or padding or both, for washing of the outer surface or padding. Access may be provided in order to separate the outer surface, and optionally the padding as well, from the electronic components such as the vibrating devices and heating element, in order to allow portions of the outer surface or padding to be washed without damage to the electronic components, and to allow access in order to replace or add electronic devices. Alternatively, an opening in the outer surface may be provided in order to provide access to replace or add electronic components such as to add additional vibrating devices as desired.

Other features and advantages of the invention will be apparent from the following detailed description taken in conjunction with the following figures, wherein like reference numerals represent like features.

### BRIEF DESCRIPTION OF THE DRAWINGS

FIG. 1 shows a neck belt apparatus according to the present invention.

FIG. 2 shows a neck belt apparatus according to the present invention revealing the inner components of the apparatus.

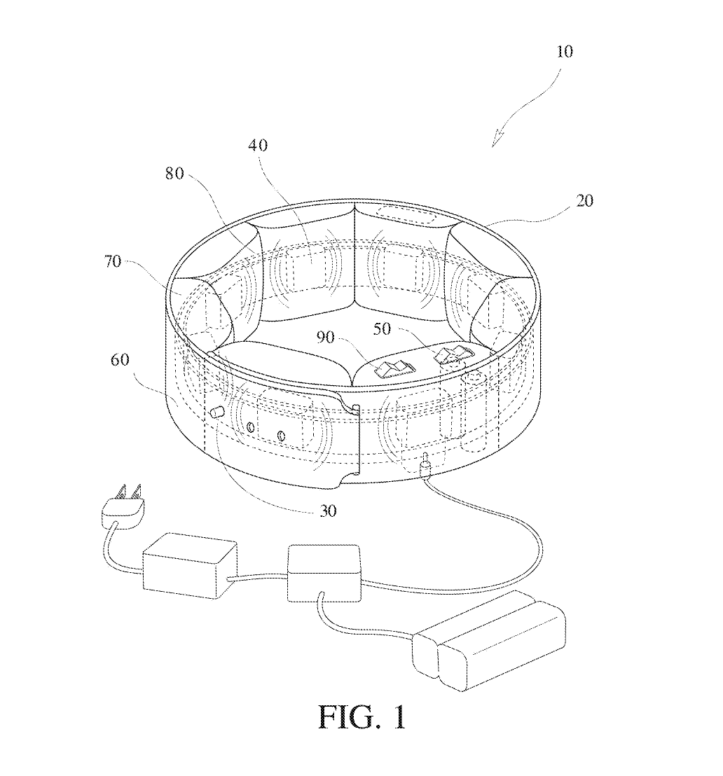

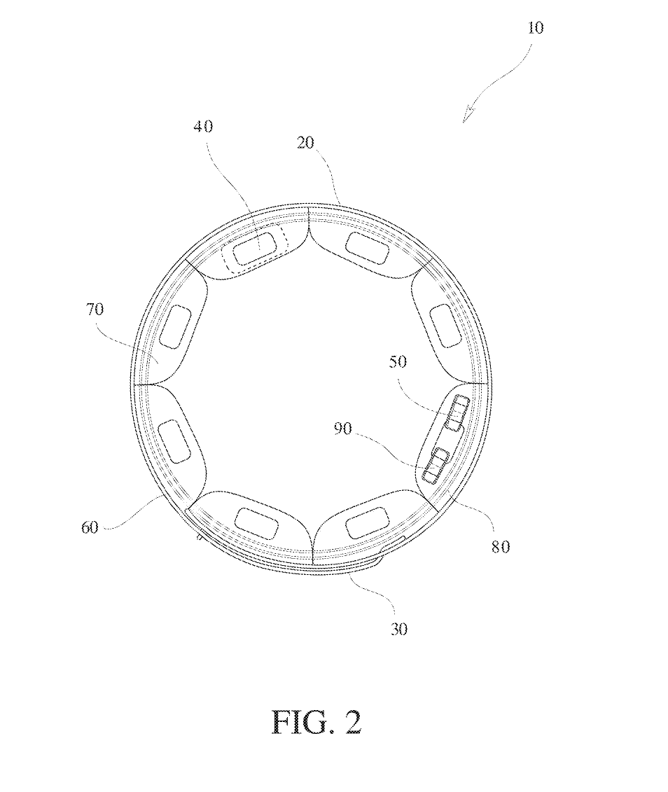

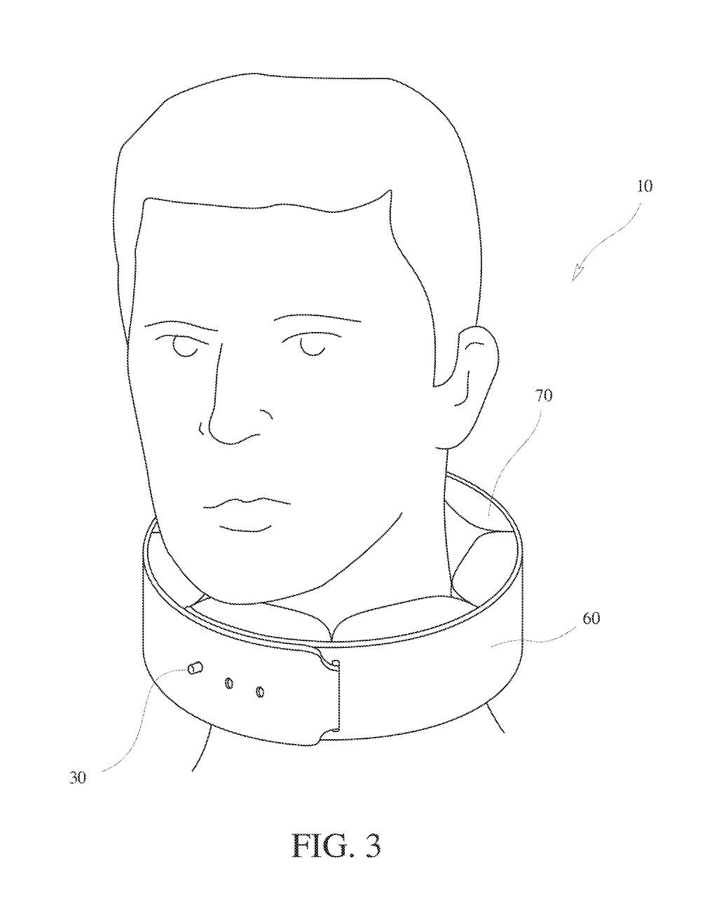

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a neck belt apparatus 10. The neck belt apparatus 10 includes a band 20 configured to fit around the neck of a user. The band 20 ideally includes a fastener 30 to adjust to fit a variety of neck sizes. Any suitable means of fastening the device is contemplated. Such means may include hook and loop fasteners, or any other suitable means for fastening.

The band 10 further includes a heating element 80 disposed therein. The heating element 80 may be any suitable device for creating heat. It may be an electrical element, or a chemical element, or an infrared device. It is disposed to transfer heat to at least a portion of the user's neck. For example, the heating element 80 can be positioned to apply heat to the front neck lower chin area, as where one might have what is commonly referred to as a “double chin” or “double neck.” In various embodiments, the heating element 80 is positioned to apply heat to a front portion of the user's neck. The heating element 80 may comprise one, two, or more heating bands positioned within the band 10. It may be powered by the same power source as the vibrating devices 40. It may also include a switch 90 with on and off positions, and optional settings such as high, low, medium. The heating element 80 can operate by itself to enable weight loss in the neck or upper chin area of the user. Alternatively, it can operate in conjunction with the vibrating devices 40 to enable weight loss in the vicinity of a user's neck. Alternatively, they may work in conjunction to provide pain relief.

In various embodiments, optionally, inside the band 20 are disposed a plurality of vibrating devices 40. The vibrating devices 40 are disposed in such a way that vibration is applied to the neck of the user. The vibrating devices 40 are powered such as electrically powered via a power cord or battery such as a rechargeable battery. In various embodiments of the invention, the vibrating devices 40 are disposed in a substantially evenly spaced manner about the band 10. In certain embodiments, eight such vibrating devices 40 are included.

A switch 50 may be operatively connected to the vibrating devices 40. The switch 50 provides on and off positions, and optionally provides the ability to set different settings for vibration, such as a high setting and a low setting.

The vibrating devices 40 are arranged to provide vibration to the neck of the user. In various embodiments, vibrating devices 40 are arranged to also provide vibration to the upper neck and underside of the chin.

The outer surface 60 of the band 10 preferably is composed of a material which is relatively non-absorbent and resistant to moisture. Material may include leather, vinyl, or any other suitable material.

Ideally, padding 70 is disposed between the heating element 80, and if included, the vibrating devices 40, and the outer surface 60. The padding 70 provides comfort. The padding 70 preferably is composed of a heat-resistant material. In various embodiments, outer surface 60 is not removable from the apparatus, however, in certain embodiments, outer surface60, and optionally padding 70, may be removed from the electronic devices or the remainder of the device for washing or in order to provide access to replace or add electronic devices.

In the battery operated embodiments of the present invention, the band 10 may be used while the user is mobile or not in the vicinity of an external power source. Thus, it may be used during travel, or during exercise.

In the manner described above, the features of the present invention can be used to accomplish weight reduction where unwanted fat tissue is present in portions of the neck, upper neck, and chin underside. The apparatus also is conducive to providing massage and pain relief.

While specific embodiments have been illustrated and described, numerous modifications come to mind without significantly departing from the spirit of the invention and the scope of protection is limited by the scope of the accompanying claims.

What is claimed is:

1. A neck belt apparatus comprising:
a band configured to fit around the neck of a user,
a heating element disposed with respect to said band wherein said heating element is positioned to supply heat to the neck of a user when in use.

2. The neck belt apparatus according to claim 1, wherein said band further comprises an adjustable fastener enabling said belt to fit a variety of neck sizes.

3. The neck belt apparatus according to claim 1, wherein said band comprises an outer surface comprising a substantially non-absorbent material.

4. The neck belt apparatus according to claim 3, wherein said relatively non-absorbent material is leather or vinyl.

5. The neck belt apparatus according to claim 3, wherein said band further comprises padding disposed between said plurality heating element and said outer surface.

6. The neck belt apparatus according to claim 5, wherein said band further comprises a plurality of vibrating devices operatively disposed within said band wherein said vibrating devices stimulate the neck of a user when in.

7. The neck belt apparatus according to claim 5, wherein said vibrating devices are operatively coupled to a user operated switch to select between an on position and an off position.

8. The neck belt apparatus according to claim 7, wherein said switch further enables a user to select between high and low settings.

9. The neck belt apparatus according to claim 6, wherein said heating element is operatively coupled to a user operated switch to select between an on position and an off position.

10. The neck belt apparatus according to claim 1, wherein said heating element is disposed to apply heat to a front portion of the neck of a user.

11. The neck belt apparatus according to claim 1, wherein said heating element comprises two heating bands disposed within said neck belt apparatus.

12. The neck belt apparatus according to claim 9, wherein said switch further enables a user to select between at least a low and high setting.

13. The neck belt apparatus according to claim 6, wherein said plurality of vibrating devices are substantially evenly spaced about a circumference of said band.

14. The neck belt apparatus according to claim 13, wherein said plurality of vibrating devices comprises eight vibrating devices.

15. The neck belt apparatus according to claim 6, wherein said heating element is operatively powered via a power cord.

16. The neck belt apparatus according to claim 5, wherein said heating element is operatively powered via a rechargeable battery.

17. The neck belt apparatus according to claim 1, wherein said heating element works to enable weight loss in the vicinity of a user's neck.

18. The neck belt apparatus according to claim 6, wherein said vibrating devices and said heating element work in conjunction to enable pain relief in the vicinity of a user's neck.

19. The neck belt apparatus according to claim 1, wherein said heating element is positioned to apply heat to the upper portion of a user's neck and to the user's skin just below the chin.

20. The neck belt apparatus according to claim 5, wherein said outer surface is separable from said heating element to enable washing of said outer surface without causing damage to said heating element.

21. The neck belt apparatus according to claim 20, wherein said padding is also separable from said heating element to enable washing of said padding without causing damage to said vibrating devices.

22. A method of facilitating the elimination of fat in the neck of a user comprising the steps of:
applying an apparatus to the neck of a user having a heating element positioned to apply heat to at least a portion of the neck,
providing a means for attachment for the apparatus to removably attach to the neck of the user.

23. The method according to claim 22, wherein the step of applying an apparatus to the neck of a user comprises positioning the heating elements to apply heat to a front portion of the neck.

24. The method according to claim 22, further comprising the step of applying vibrating devices positioned within the apparatus to apply vibration to the neck of the user.
